(19) United States
(12) Patent Application Publication
(10) Pub. No.: US 2019/0207515 A1
(43) Pub. Date: Jul. 4, 2019

(54) METHOD AND SYSTEM OF OPERATING SWITCHING POWER CONVERTERS BASED ON PEAK CURRENT THROUGH THE SWITCHING ELEMENT

(71) Applicant: SEMICONDUCTOR COMPONENTS INDUSTRIES, LLC, Phoenix, AZ (US)

(72) Inventor: Chen-Hua CHIU, New Taipei City (TW)

(73) Assignee: SEMICONDUCTOR COMPONENTS INDUSTRIES, LLC, Phoenix, AZ (US)

(21) Appl. No.: 15/856,147

(22) Filed: Dec. 28, 2017

(51) Int. Cl. H02M 3/156; H02M 7/06; H02M 1/08; H02M 1/44

(52) U.S. Cl. CPC H02M 3/156; H02M 1/44; H02M 1/08; H02M 7/06

(57) ABSTRACT

Operating switching power converters based on peak current through the switching element. At least some of the example embodiments are controllers for buck-type power converters including a gate drive terminal, a feedback terminal, and a drain current terminal. The controllers are configured to generate variable frequency gate drive signals applied to the gate drive terminal, the frequency controlled based on a time-varying reference signal that controls peak current through a switching transistor, and the frequency controlled based on a feedback signal received on the feedback terminal proportional to a sampled output voltage.

### CROSS-REFERENCE TO RELATED APPLICATIONS

Not Applicable.

### BACKGROUND

The electromagnetic interference (EMI) produced by electronic devices is regulated in most industrialized countries. Switching power supplies generate EMI, and thus designs of switching power supplies take into account reducing EMI produced. The design considerations include physical shielding of the underlying circuits, EMI filters on input and output signals, and also design of the underlying circuits themselves. Any advance in the design of switching power supplies that reduces complexity of control of the switching power supply and/or reduces EMI produced may provide a competitive advantage in the marketplace.

### BRIEF DESCRIPTION OF THE DRAWINGS

For a detailed description of example embodiments, reference will now be made to the accompanying drawings in which:

FIG. 1 shows a block diagram of an AC/DC switching power supply in accordance with at least some embodiments;

FIG. 2 shows a circuit diagram of an AC/DC switching power supply in accordance with at least some embodiments;

FIG. 3 shows a timing diagram in accordance with at least some embodiments;

FIG. 4 shows plots of modulated peak current and resulting switching frequency in accordance with at least some embodiments;

FIG. 5 shows an analog reference signal circuit in accordance with at least some embodiments;

FIG. 6 shows a digital reference signal circuit in accordance with at least some embodiments; and

FIG. 7 shows a method in accordance with at least some embodiments.

### NOTATION AND NOMENCLATURE

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

The terms “input” and “output” refer to electrical connections to electrical devices, and shall not be read as verbs requiring action. For example, a set-reset (SR) flip-flop may have set input, a reset input, and an SR output. These “inputs” and “output” define electrical connections to the flip-flop, and shall not be read to require inputting signals to the SR flip-flop or outputting signals by the SR flip-flop.

“Gate” shall refer to the gate of a metal-oxide-semiconductor field-effect transistor (MOSFET), and also shall refer to the base of a bipolar junction transistor (BJT). Thus, reference to a “gate” of a transistor shall not imply that the transistor is limited to a MOSFET. “Drain” shall refer to a higher voltage terminal of a transistor, and “source” shall refer to a lower voltage terminal of the transistor, of either a MOSFET (e.g., N-channel or P-Channel) or a BJT (e.g., NPN or PNP). Thus again, reference to a “drain” and/or a “source” shall not imply that the transistor is limited to a MOSFET, a BJT, any particular type of MOSFET, or any particular type of BJT.

“Set-Reset flip-flop” or “SR flip-flop” shall mean any set of circuitry that executes a state diagram or state table of an SR flip-flop (e.g., cross-coupled NAND gates, or a D flip-flop having the D input asserted with the clear input acting as a reset and the clock input acting as the set input).

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various embodiments are directed to methods and systems of operating alternating current (AC) to direct current (DC) (AC/DC) switching power supplies based on peak current through the switching element. More particularly, various embodiments are directed to methods and systems of DC/DC buck-type converters within switching power supplies, the DC/DC buck-type converters operate based on controlling peak current through the switching element (or peak current through an inductor). By modulating a reference signal that controls peak current through the switching element, electromagnetic interference (EMI) produced may be reduced. The specification first turns to a high level overview to orient the reader.

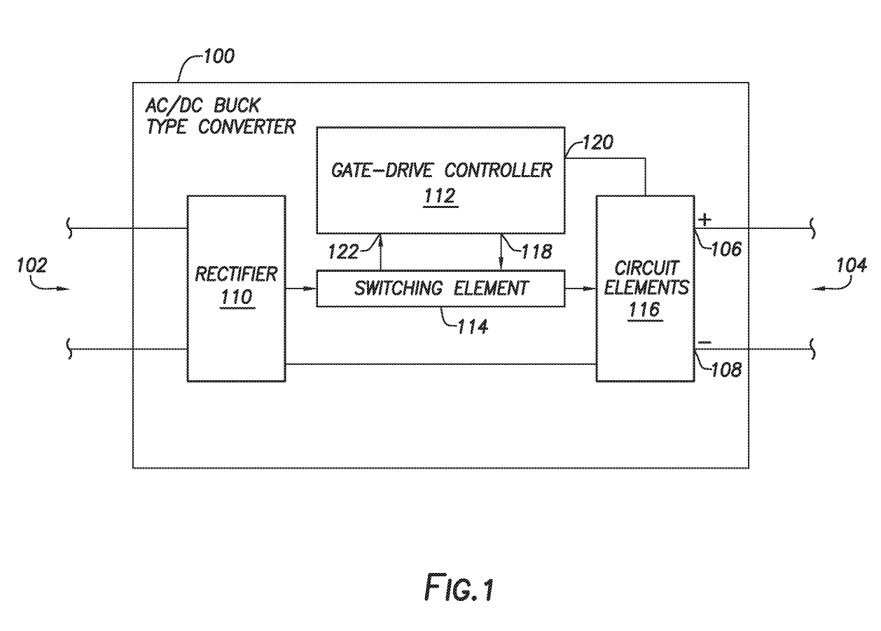

FIG. 1 shows a block diagram of an AC/DC switching power supply in accordance with at least some embodiments. In particular, FIG. 1 shows AC/DC switching power supply 100 defines a set of AC input terminals 102, and a set of DC output terminals 104 comprising positive terminal 106 and return terminal 108. In operation and AC voltage is applied to the AC input terminal 102 (e.g., an AC voltage having peak voltage of 20 Volts or more), and the AC/DC switching power supply produces a DC voltage on the DC output terminals 104 (e.g., 3 Volts or 5 Volts), and thus the DC portion may be considered a DC/DC buck-type converter. The AC/DC switching power supply 100 may be conceptually (though not necessarily physically) divided into a rectifier 110, a gate-drive controller 112, switching element 114, and circuit elements 116. The rectifier 110 couples to the circuit elements 116 through the switching element 114. The gate-drive controller 112 defines a gate-drive terminal 118, a feedback terminal 120, and a drain current terminal 122. The gate-drive controller 112 produces a gate-drive signal on the gate-drive terminal 118 that selectively drives the switching element 114. Switching states (e.g., asserted and non-asserted) of the gate-drive signal is based on a feedback signal received through the feedback terminal 120, and is based on a current signal received over the drain current terminal 122, where a parameter of the current signal (e.g., voltage) is indicative of the electrical current through the switching element 114 when the switching element 114 is in a conductive state. Current provided through the switching element 114 is provided to the circuit elements 116. The circuit elements 116 modify the current provided through the switching element 114 to provide a DC output voltage and current across the DC output terminals 104. The circuit elements 116 also sample an output voltage provided on the DC output terminals 104, and create a feedback signal (e.g., a feedback voltage proportional to output voltage on the DC output terminals) that is provided to the feedback terminal 120 of the gate-drive controller 112.

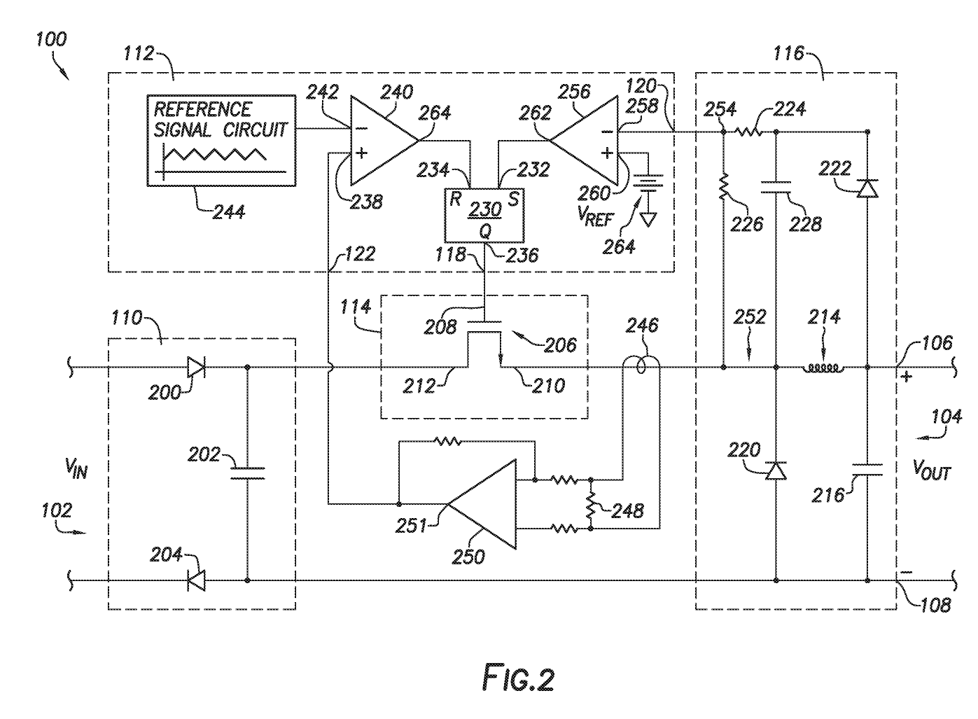

FIG. 2 shows a circuit diagram of an AC/DC switching power supply in accordance with at least some embodiments. In particular, FIG. 2 shows the AC input terminals 102, the DC output terminals 104, the rectifier 110, the gate-drive controller 112, the switching element 114, and the circuit elements 116. In the example system of FIG. 2, the rectifier 110 comprises a diode 200 having its anode coupled to one terminal of the AC input terminals 102, and its cathode coupled to a first lead of capacitor 202. The second lead of capacitor 202 is coupled to an anode of diode 204, and the cathode of diode 204 is coupled to the second lead of the AC input terminals 102. Thus, the example rectifier 110 is a half-wave rectifier. However, depending on the amount of DC output voltage and current for which the system is designed, a full-wave rectifier may be used. Moreover, for efficiency the rectifier may also use active switching elements to reduce internal power loss (e.g., diode forward conduction loss). In the example system, the rectifier creates a rectified signal having a peak voltage higher than an output voltage Vout across the DC output terminals 104.

In the example system the switching element 114 is shown as a transistor 206 in the form of an N-channel MOSFET; however, any suitable type of transistor may be used. The transistor 206 defines a gate 208, a source 210, and a drain 212. The gate 208 is coupled to the gate-drive terminal 118 of the gate-drive controller 112. The drain 212 is coupled to the rectifier 110, and the source 210 is coupled to the circuit elements 116. The example circuit elements 116 comprise an inductor 214. The first lead of the inductor 214 is coupled to the positive terminal 106 of the DC output terminals 104. The second lead of the inductor 214 is coupled to the source 210 of the transistor 206. Coupled between the positive terminal 106 and the return terminal 108 is a capacitor 216. The capacitor 216 acts as a low pass filter for the DC output voltage created by the system. The example circuit elements 116 further comprise a freewheeling diode 220 that defines an anode coupled to the return terminal 108 of the DC output terminals 104, and a cathode coupled to the second lead of the inductor 214. The example circuit further comprises freewheeling diode 222 that defines an anode coupled to the first lead of the inductor 214, and a cathode coupled to a resistor network comprising resistor 224 and resistor 226 in series between the cathode of diode 222 and the second lead of the inductor 214. The node 254 between the resistors 224 and 226 is coupled to the feedback terminal 120 of the gate-drive controller 112. A capacitor 228 is coupled in parallel with the resistors 224 and 226 such that the capacitor 228 has a first lead coupled to the cathode of diode 222 and a second lead coupled to the second lead of the inductor 214.

Still referring to FIG. 2, in example embodiments the various circuits of the gate-drive controller 112 are all constructed monolithically on a semiconductor substrate, and may be a packaged component (e.g., encapsulated in epoxy with metallic leads extending therefrom) combined with individual circuit elements to create the overall system shown. Certain additional low-current components of the circuit elements 116 may also be monolithically constructed on the substrate, such as the freewheeling diode 222, capacitor 228, and resistors 224 and 226. The example gate-drive controller 112 includes a bistable multivibrator in the example form of Set-Reset (SR) flip-flop 230 that defines a set input 232, a reset input 234, and an SR output 236 (labeled “Q” in the figure). In operation, the SR output 236 is asserted when the set input 232 is asserted, and the SR output 236 remains asserted (even after the set input becomes de-asserted) until the reset input 234 is asserted. The SR output 236 of the SR flip-flop 230 is coupled to the gate-drive terminal 118, and thus is coupled to the gate 208 of the transistor 206. The gate-drive controller 112 includes the drain current terminal 122 that couples to a positive input 238 of a comparator 240. The negative input 242 of the comparator 240 couples to a reference signal circuit 244 (discussed in greater detail below). The reference signal circuit 244 creates a time-varying reference signal that is applied to the negative input 242 of the comparator 240. The time-varying reference signal controls a peak current through the transistor 206, at which peak current the SR output 236 is de-asserted. Moreover, the time-varying reference signal in accordance with example embodiments is modulated. Having the peak current through the transistor 206 change slightly across each switching cycle (in response to the modulated time-varying reference signal) causes a frequency of the gate-drive signal on the gate-drive terminal 118 to be variable, which may result in reduced EMI produced by the system of FIG. 2.

In example embodiments, a signal is provided to the drain current terminal 122 of the gate-drive controller 112, where the signal has a parameter proportional to the electrical current flowing through the transistor 206. In the example system of FIG. 2, the signal is a voltage proportional to current flow through the transistor 206 created by a current-sense transformer 246 operatively coupled to the current flow exiting the source 210 and entering the inductor 214. That is, the primary of the current-sense transformer 246 is a single “turn” of the electrical lead between the source 210 and the inductor 214, and the secondary of the current-sense transformer 246 is one or more turns of wire electrically coupled in series with a shunting resistor 248. The example current-sense transformer 246 is operatively coupled to the inputs of a differential amplifier 250. The differential amplifier 250 produces on its output 251 a voltage proportional to current flow through the transistor 206. The output 251 is thus coupled to the drain current terminal 122. Other methods and systems of producing the signal with a voltage proportional to current flow through the transistor 206 may be used. For example, a small current sense resistor may be placed in series between the source 210 and the inductor 214, with the voltage across the small resistance being proportional to current flow. Further still, some commercially available MOSFETs are designed and constructed to inherently produce a separate signal with a voltage proportional to current flow through the MOSFET (under the brand name SENSEFET® of ON Semiconductor), and when such a transistor is used the example current-sense transformer 246, differential amplifier 250, etc., may be omitted. Any system and method that senses electrical current through the transistor 206 or the inductor 214 may be used.

Still referring to FIG. 2, consider that the transistor 206 is conductive, and thus drives current through the inductor. The trigger for driving current through the inductor is discussed more below after a discussion of sampling of the output voltage Vout by the circuit elements 116. When the transistor 206 becomes conductive, electrical current begins to build through the inductor 214, and as the current builds the inductor stores energy in the field of the inductor 214. The current flow through the inductor flows into capacitor 216 and through the load coupled to the DC output terminals 104. During the period of time when the transistor 206 is driving current, the freewheeling diode 220 is reversed biased because the voltage at node 252 is higher than the voltage at the return terminal 108. Likewise, freewheeling diode 222 is reversed biased because the voltage at node 252 is higher than the voltage at the positive terminal 106. In accordance with example embodiments, driving of the current through the inductor 214 ceases when current through the transistor 206 reaches a peak value. That is, in the example circuit current-sense transformer 246 and differential amplifier 250 create a signal with a voltage proportional to current flow, and when the current reaches the peak value (as determined by comparator 240), the example circuit de-asserts the signal on the gate-drive terminal 118, and thus ceases driving current through transistor 206.

Electrical current through the inductor 214 cannot change instantaneously. Rather, when driving current ceases the field surrounding the inductor 214 begins to collapse which produces voltage and thus a current flow through the inductor 214 into the load and/or capacitor 216. The voltage produced by the inductor 214 during the field collapse lowers the voltage on node 252, which forward biases freewheeling diode 220 and which enables the return current in the return terminal 108 to flow through the freewheeling diode 220. Also, the lowered voltage on node 252 forward biases freewheeling diode 222 and momentarily current flows through freewheeling diode 222 into the capacitor 228. In effect, just after ceasing of the current flow through the transistor 206, the example circuit elements 116 sample the output voltage Vout, which sampled voltage then resides on the capacitor 228. The voltage on capacitor 228 created during the sampling then discharges through the resistors 224 and 226. The discharge rate of the capacitor 228 is set by the resistors 224 and 226, and note that the discharge rate is independent of the actual output voltage Vout once the freewheeling diode 222 is no longer forward biased. The node 254 between the two example resistors 224 and 226 is coupled to the feedback terminal 120 of the gate-drive controller 112, and gate-drive controller 112 uses the feedback voltage at node 254 to trigger the next asserted signal on the gate-drive terminal 118. If the system of FIG. 2 is operated in a discontinuous conduction mode (DCM) of the inductor, the field fully collapses and the inductor 214 no longer provides current prior to the next switching period in which the transistor 206 drives current through the inductor 214. If the system of FIG. 2 is operated in a continuous conduction mode (CCM), the current through the inductor 214 will still be a non-zero value at the beginning of the next switching period when again the transistor 206 begins to drive current through the inductor 214.

Still referring to FIG. 2, and turning again to operation of the gate-drive controller 112. The gate-drive controller 112 further comprises comparator 256 that defines a negative input 258, a positive input 260, and a comparator output 262. The negative input 258 is coupled to the feedback terminal 120 and thus the feedback voltage created by the circuit elements 116. The positive input 260 is coupled to a reference voltage Vref 264. Thus, when the feedback voltage on the negative input 258 falls below the reference voltage Vref 264, the comparator output 262 is asserted. The comparator output 262 is coupled directly to the set input 232. Thus, the gate-drive terminal 118 is asserted when the feedback voltage falls below the reference voltage Vref 264. Returning again to comparator 240, comparator 240 defines a comparator output 262 that couples directly to the reset input 234 of the SR flip-flop 230. It follows that when the signal with a voltage proportional to current flow through the transistor 206 exceeds the signal created by the reference signal circuit 244 (i.e., when the electrical current reaches the peak value), the comparator output 262 becomes asserted, which resets or de-asserts the signal on the gate-drive terminal 118 ceasing current flow through the transistor 206. Thus, the example gate-drive controller 112 has no internal oscillator. The frequency at which the transistor 206 is controlled is based on the discharge time of the sampled voltage (i.e., discharge time of the feedback voltage) and the amount of time it takes to reach the peak current. As discussed in more detail below, the threshold peak current is dithered, which results in varying frequency of operation of the controller. The specification now turns to example timing diagrams of the example system.

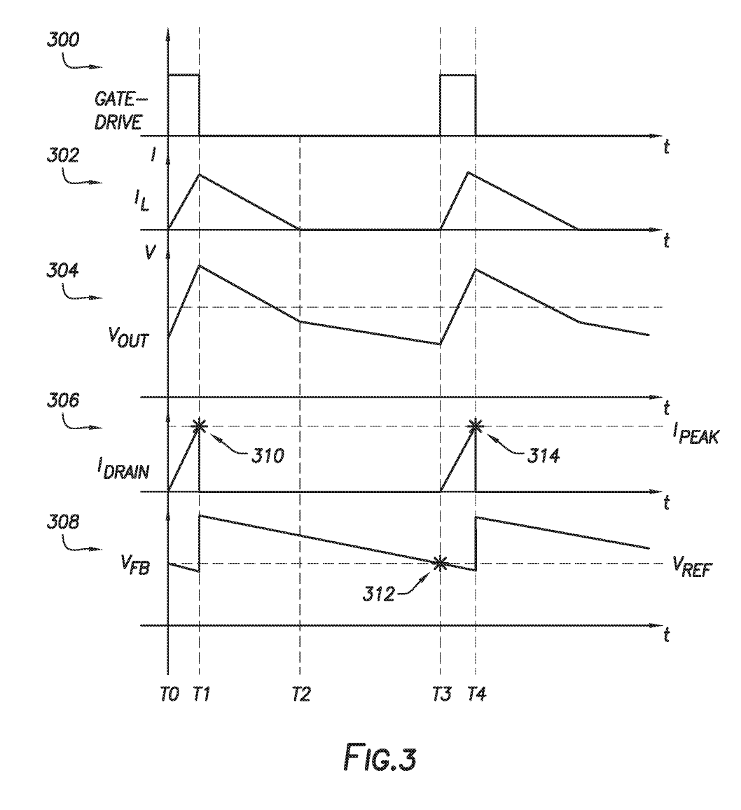

FIG. 3 shows a timing diagram in accordance with at least some embodiments. In particular, FIG. 3 shows five parameters plotted on a set of corresponding time axis. Plot 300 shows the gate-drive voltage as a function of time. Plot 302 shows inductor current I_{L} as a function of time (for an example DCM operation). Plot 304 shows output voltage Vout (e.g., at the DC output terminals 104 (FIG. 1, 2)). Plot 306 shows drain current I_{DRAIN} through the transistor 206 as a function of time. And plot 308 shows the feedback voltage V_{FB} as a function of time. In particular, at time T0 the gate drive voltage becomes asserted (plot 300). Responsive to the asserted gate-drive signal, the transistor 206 current I_{DRAIN} begins to rise (plot 306), the inductor current I_{L} begins to rise (plot 302), and output voltage Vout begins to rise (plot 304). Charging of the inductor continues until the transistor 206 current I_{DRAIN} reaches a peak value I_{PEAK} at time T1 (designated as point 310 in plot 306). Responsive to the I_{DRAIN} reaching I_{PEAK}, the gate-drive signal is de-asserted. When the transistor 206 is made non-conductive by de-assertion of the gate-drive signal (at time T1), the transistor 206 current I_{DRAIN} drops to zero. However, because the energy stored in the field of the inductor 214, when I_{DRAIN} drops to zero the field begins to collapse, which reverses the voltage across the inductor 214 and forward biases the freewheeling diode 222. Thus the output voltage Vout is sampled at time T1 (or slightly thereafter), as shown by feedback voltage V_{FB} jumping to a peak value (plot 308 at time T1).

Between time T1 and T2, the inductor current I_{L} decreases from its peak value as the energy stored in the field collapses. Relatedly, the output voltage Vout also drops as the component of the output power provided the inductor 214 drops as a function of current flow through the inductor 214. In the example DCM operation shown, when the inductor current reaches zero at T2, the energy provided to the load is supplied exclusively from the capacitor 216. Notice, however, that in accordance with example embodiments feedback voltage V_{FB} falls off at a rate independent of the inductor current I_{L} or the output voltage Vout. As discussed above, discharge of the feedback voltage V_{FB} is controlled by the resistor network comprising resistors 224 and 226. When the feedback voltage V_{FB} reaches a predetermined value Vref 264 at time T3 (designated as point 312 in plot 308), the process begins anew by the gate drive voltage becoming asserted (plot 300). Between time T3 and T4 transistor 206 current I_{DRAIN} begins to rise, the inductor current I_{L} begins to rise, and output voltage Vout begins to rise. Charging of the inductor continues until the transistor 206 current I_{DRAIN} reaches a peak value I_{PEAK} at time T4 (designated as point 310 in plot 306), and so on.

There are two time periods that control the frequency at which the overall circuit operates. First, the charging period (e.g., T0-T1, and T3-T4) that starts each time with the feedback voltage V_{FB} reaches a predetermined value Vref, and ends when transistor current I_{DRAIN} reaches a peak value I_{PEAK}. The discharging period (e.g., T2-T3) that effectively starts each time when the transistor current I_{DRAIN} reaches a peak value I_{PEAK}, and ends when feedback voltage V_{FB} reaches a predetermined value Vref. Though the example system may be operated with fixed I_{PEAK} and fixed Vref value, in accordance with at least some embodiments the I_{PEAK} value is modified or modulated to reduce EMI produced by the system.

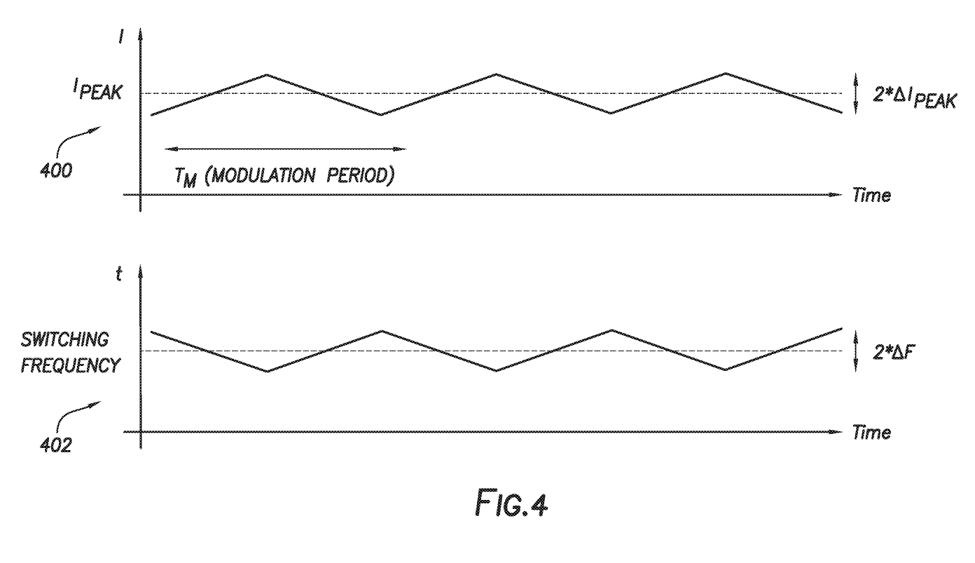

FIG. 4 shows plots of modulated peak current and resulting switching frequency in accordance with at least some embodiments. In particular, plot 400 shows an I_{PEAK} value modified as a function of time or modulated to change slightly the I_{PEAK} value and thus the length of the charging period of the inductor. In the example plot 400, the I_{PEAK} value is a time-varying reference signal in the form of a triangle wave with a modulate period TM between any two consistent features (as shown, the consistent features between lowest voltage). It is noted, however, that the time-varying reference signal need not be a triangle wave as other time varying reference signals may be used, such as a sinusoid or a saw tooth wave. In the example plot of 400, the triangle wave rides a DC voltage and has a peak-to-peak change in voltage of twice ΔI_{PEAK}. The modulation of the I_{PEAK} value results in variation of the switching frequency over time, as shown by plot 402 of the FIG. 4. The specification now turns to a mathematical analysis to help quantify the relationship between variations in I_{PEAK} and resulting variations in switching frequency.

Consider, for purposes of explanation, a DC/DC buck converter operated using a constant I_{PEAK} value. In DCM operation, the relationship between power output of the converter and various voltages and currents take the form:

$${P}_{OUT . DCM} = {V}_{OUT} \cdot {I}_{OUT} = \frac{1}{2} \cdot \frac{{V}_{IN}}{( {V}_{IN} - {V}_{OUT} )} \cdot L \cdot {I}_{PEAK}^{2} \cdot f \qquad ( 1 )$$

where P_{OUT}_{_}_{DCM} is the power output, V_{OUT} is the output voltage as above, I_{OUT} is the output current, V_{IN} is the DC input voltage to the buck-type converter, L is the inductance of the inductor, I_{PEAK} is the peak current as above, and f is switching frequency. Similarly for CCM operation:

$${P}_{OUT . CCM} = {V}_{OUT} \cdot {I}_{OUT} = {V}_{OUT} \cdot {I}_{PEAK} - \frac{( {V}_{IN} - {V}_{OUT} ) \cdot {V}_{OUT}^{2}}{2 \cdot {V}_{IN} \cdot L} \cdot \frac{1}{f} . \qquad ( 2 )$$

Assume that V_{IN}, V_{OUT}, L, and I_{OUT} are constant. If I_{PEAK} is replaced in each equation by I_{PEAK}+ΔI_{PEAK}, it can be proved that in DCM operation:

$$\frac{Δ f}{f} ≅ - 2 \cdot \frac{Δ {I}_{PEAK}}{{I}_{PEAK}} \qquad ( 3 )$$

And in CCM operation:

$$\frac{Δ f}{f} ≅ - \frac{Δ {I}_{PEAK}}{{I}_{PEAK} - {I}_{OUT}} \qquad ( 4 )$$

Thus, the switching frequency is related to the ΔI_{PEAK} of the time-varying reference signal. Plot 402 shows that, in an example DCM operation, the change in switching frequency Δf is directly related to the ΔI_{PEAK}. Thus, by modifying or modulating the I_{PEAK} at which charging the inductor ceases, the result is a change in switching frequency of the converter.

Before proceeding to example circuits to provide the time-varying reference signal which sets the I_{PEAK}, it is noted that the V_{IN} to the buck-type converter is assumed to be constant. However, the rectifier 110 (FIGS. 1 and 2) in example embodiments is discussed to be a half-wave rectifier in some embodiments. While the capacitor 202 may smooth the half-wave rectified signal to some extent, it is likely the voltage produced by the rectifier 110 (i.e., the V_{IN} to the buck-type converter) will have a ripple at twice the frequency of the AC input signal to the rectifier. With the switching frequency of the buck-type converter (e.g., 1 kilo-Hertz or above) being higher than the frequency of the AC signal used to create the V_{IN} by the rectifier 110, the V_{IN} voltage at which the charging begins in each switching cycle may also be different. Moreover, the output voltage V_{OUT} at the point in time when charging the inductor begins may not be constant. The input voltage V_{IN} and output voltage V_{OUT} affect the charging time to reach I_{PEAK}, and thus the modification or modulation of I_{PEAK} in the various embodiments works in conjunction with the variation caused time instantaneous V_{IN} and V_{OUT} when charging begins in each cycle.

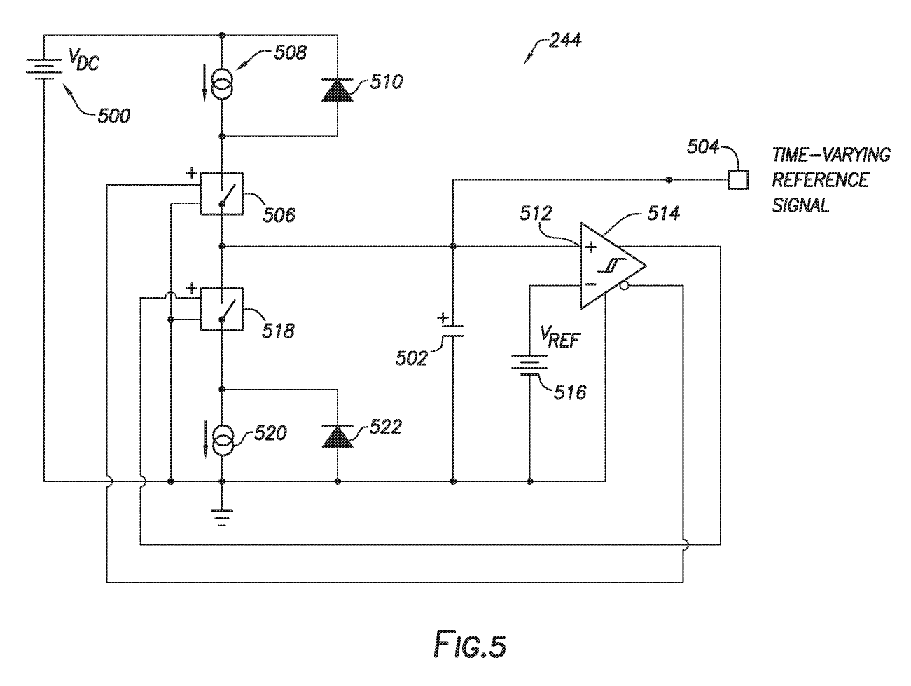

FIG. 5 shows an analog reference signal circuit in accordance with at least some embodiments. In particular, reference signal circuit 244 of FIG. 5 is an analog circuit configured to create the time-varying reference signal applied to the negative input 242 (FIG. 2) of the comparator 240 (FIG. 2). The example circuit comprises base or DC voltage reference V_{DC} 500. The V_{DC} 500 is initially applied to the capacitor 502 and time-varying signal port 504 through switch 506. The voltage provided by V_{DC} 500 is increased slightly by constant current source 508 (paralleled by snubbing diode 510). The voltage on capacitor 502 is also coupled to the positive input 512 of comparator 514. When the voltage on the capacitor 502 exceeds the V_{REF} 516 (taking into account the hysteresis of the comparator), comparator 514 changes state on its outputs. The change of state causes switch 506 to open, and switch 518 to close. The voltage on the capacitor 502 is then reduced by constant current source 520 (paralleled by snubbing diode 522). When the voltage on capacitor 502 falls below V_{REF} 516 (taking into account the hysteresis of the comparator), again the comparator 514 changes state, and the process continues. The peak-to-peak amplitude of the signal on the time-varying signal port 504 is based on the hysteresis of the comparator 514. Thus, the example reference signal circuit 244 of FIG. 5 produces, using analog signals, a time-varying reference in the form of a triangle wave.

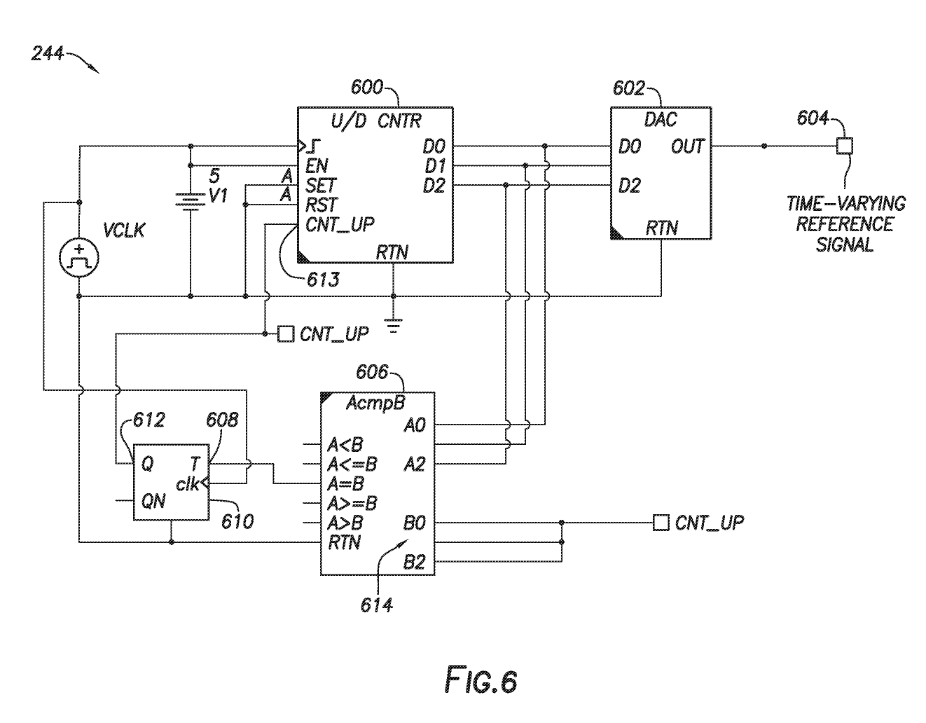

FIG. 6 shows digital reference signal circuit in accordance with at least some embodiments. In particular, reference signal circuit 244 of FIG. 6 is a digital circuit configured to create the time-varying reference signal applied to the negative input 242 (FIG. 2) of the comparator 240 (FIG. 2). The heart of the example reference signal circuit 244 of FIG. 6 is the up/down counter 600. Consider that the up/down counter 600 initially counts up, producing a three-bit value on the outputs D0, D1, and D2. The example three-bit value is applied to a digital to analog converter (DAC) 602 that produces the time-varying reference signal on the time-varying signal port 604. However, the example three-bit value is also applied to a digital comparator 606, and when the three-bit value equals a predetermined digital value (in the example, the predetermined digital value being “111”), the digital comparator 606 produces an asserted signal (the “A=B” output) coupled to the T input 608 of a toggle flip-flop 610. On the next clock cycle applied to toggle flip-flop 610, the Q output 612 toggles or changes state (in this example, from asserted to de-asserted). The Q output 612 is coupled to not only the count up/down input 613 of the up/down counter 600, but is also tied to all the B comparison inputs 614 of the digital comparator 606. Thus, the de-asserted state of the count up/down input 613 causes the up/down counter 600 then to count down. When again the count value equals the predetermined value on the B comparison inputs 614 (now “000”), the toggle flip-flop 610 again toggles its Q output 612, and the process repeats by counting up. Thus, the example reference signal circuit 244 of FIG. 6 produces, using digital signals, a time-varying reference in the form of a triangle wave. As noted before, triangle waves are merely an example of a time-varying reference signal, and thus other digital and analog circuits producing other types of time-varying signals may be used.

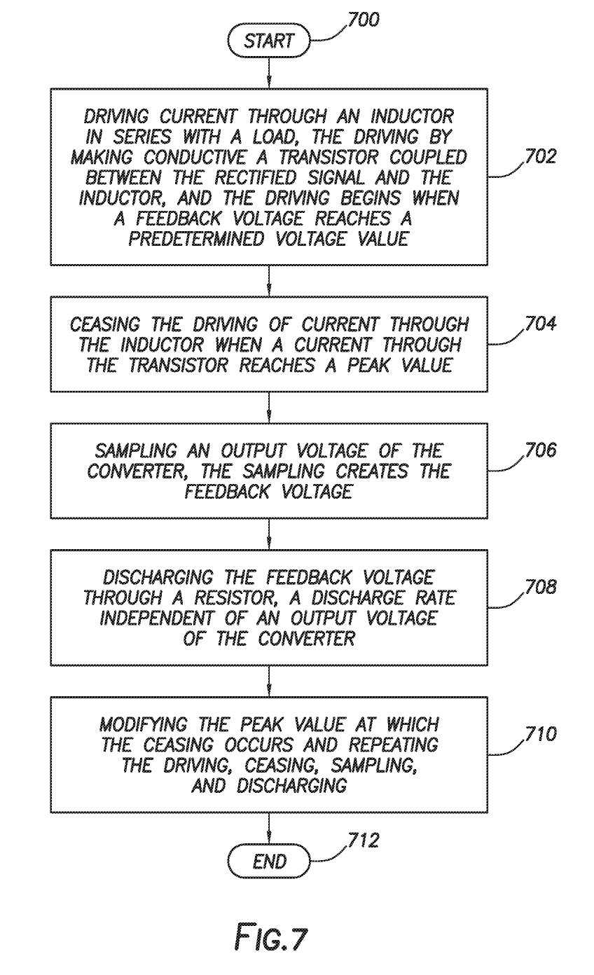

FIG. 7 shows a method in accordance with at least some embodiments. In particular, the method starts (block 700) and comprises: driving current through an inductor in series with a load, the driving by making conductive a transistor coupled between the rectified signal and the inductor, and the driving begins when a feedback voltage reaches a predetermined voltage value (block 702); ceasing the driving of current through the inductor when a current through the transistor reaches a peak value (block 704); sampling an output voltage of the converter, the sampling creates the feedback voltage (block 706); discharging the feedback voltage through a resistor, a discharge rate independent of an output voltage of the converter (block 708); and modifying the peak value at which the ceasing occurs and repeating the driving, ceasing, sampling, and discharging (block 710). Thereafter the method ends (block 712).

The above discussion is meant to be illustrative of the principles and various embodiments of the present invention. It is intended that the following claims be interpreted to embrace all such variations and modifications.

1. A controller for a buck-type power converter, the controller comprising:
a gate drive terminal;
a feedback terminal;
a drain current terminal;
a reference signal circuit, the reference signal circuit configured to create a time-varying reference signal with a modulation period that is constant;
a set-reset (SR) flip-flop, the SR flip-flop has a set input, a reset input, and an SR output, the SR output coupled to the gate drive terminal of the controller;
a first comparator that has a first input, a second input, and a comparator output, the comparator output coupled to the set input of the SR flip-flop;
a reference voltage coupled to the first input of the first comparator, and the feedback terminal coupled to the second input of the first comparator;
a second comparator that has a first input, a second input, and a comparator output, the comparator output of the second comparator coupled to the reset input of the SR flip-flop; and
the drain current terminal coupled to the first input of the second comparator, and the time-varying reference signal coupled to the second input of the second comparator;
wherein the controller is configured to assert the gate drive terminal when a feedback signal on the feedback terminal crosses the reference voltage, and the controller is configured to de-assert the gate drive terminal when a drain current signal on the drain current terminal crosses the time-varying reference signal.

2. The controller of claim 1 wherein the reference signal circuit further comprises an analog circuit configured to create the time-varying reference signal.

3. The controller of claim 1 wherein the reference signal circuit further comprises a digital circuit configured to create the time-varying reference signal.

4. The controller of claim 1 wherein the reference signal circuit is configured to create a triangle wave.

5. The controller of claim 1 wherein the reference signal circuit is configured to create at least one selected from a group comprising: the time-varying reference signal in the form of a triangle wave; and the time-varying reference signal in the form of a saw tooth wave.

6. The controller of claim 1:
wherein the first comparator output is coupled directly to the set input of the SR flip-flop; and
wherein the comparator output of the second comparator is coupled directly to the reset input of the SR flip-flop.

7.-14. (canceled)

15. A gate-drive controller comprising:
a gate drive terminal configured to couple to the gate of a transistor;
a feedback terminal configured to couple to a capacitor;
a drain current terminal;
a reference signal circuit configured to create a time-varying reference signal with a modulation period that is unaffected by switching frequency of a gate drive signal;
a bistable multivibrator, the bistable multivibrator has a set input, a reset input, and an output, the bistable multivibrator coupled to the gate drive terminal;
a first comparator that has a first input, a second input, and a comparator output, the comparator output coupled to the set input of the bistable multivibrator;
a reference voltage coupled to the first input of the first comparator, and the feedback terminal coupled to the second input of the first comparator;
a second comparator that has a first input, a second input, and a comparator output, the comparator output of the second comparator coupled to the reset input of the bistable multivibrator; and
the drain current terminal coupled to the first input of the second comparator, and the time-varying reference signal coupled to the second input of the second comparator;
wherein the gate-drive controller is configured to assert the gate drive terminal when a feedback signal on the feedback terminal crosses the reference voltage, and the controller is configured to de-assert the gate drive terminal when a drain current signal on the drain current terminal crosses the time-varying reference signal.

16. The gate-drive controller of claim 15 wherein the reference signal circuit further comprises an analog circuit configured to create the time-varying reference signal.

17. The gate-drive controller of claim 15 wherein the reference signal circuit further comprises a digital circuit configured to create the time-varying reference signal.

18. The gate-drive controller of claim 15 wherein the reference signal circuit is configured to create a triangle wave.

19. The gate-drive controller of claim 15 wherein the reference signal circuit is configured to create at least one selected from a group comprising: the time-varying reference signal in the form of a triangle wave; and the time-varying reference signal in the form of a saw tooth wave.

20. The gate-drive controller of claim 15:
wherein the first comparator output is coupled directly to the set input of the bistable multivibrator; and
wherein the comparator output of the second comparator is coupled directly to the reset input of the bistable multivibrator.

21. The controller of claim 1 wherein the reference signal circuit is configured to create the time-varying reference signal in the form of a sinusoid having the modulation period.

22. The controller of claim 1 wherein the controller is configured to operate the buck-type power converter in discontinuous current mode.

23. The gate-drive controller of claim 15 wherein the reference signal circuit is configured to create the time-varying reference signal in the form of a sinusoid.

24. The gate-drive controller of claim 15 wherein the gate-drive controller is configured to operate a buck-type power converter in discontinuous current mode.

25. A buck-type power converter comprising:
a transistor defining a gate, a source, and a drain, the drain coupled to a voltage input;
an inductor defining a first lead and a second lead, the first lead coupled to the source, and the second lead coupled to a positive terminal of a voltage output;
a first diode defining an anode and a cathode, the anode coupled to a negative terminal of the voltage output, and the anode coupled to the first lead of the inductor;
a voltage sample circuit comprising a second diode defining an anode and a cathode, a voltage divider defining a first lead and second lead, and a capacitor defining a first lead and a second lead, the second diode coupled in series with the voltage divider, the capacitor in parallel with the voltage divider, an anode of the second diode coupled to the second lead of the inductor, and the second lead of the voltage divider and the second lead of the capacitor coupled to the first lead of the inductor;
a means for sensing current flow through the transistor, the means for sensing defines a current sense output;
a gate-drive controller comprising:
a gate drive terminal coupled to the gate of the transistor;
a feedback terminal coupled to the voltage sample circuit;
a drain current terminal coupled to the current sense output;
a reference signal circuit configured to create a time-varying reference signal with a modulation period that is constant;
a bistable multivibrator, the bistable multivibrator defining a set input, a reset input, and an output, the bistable multivibrator coupled to the gate drive terminal;
a first comparator that has a first input, a second input, and a comparator output, the comparator output coupled to the set input of the bistable multivibrator;
a reference voltage coupled to the first input of the first comparator, and the feedback terminal coupled to the second input of the first comparator;
a second comparator that has a first input, a second input, and a comparator output, the comparator output of the second comparator coupled to the reset input of the bistable multivibrator; and
the drain current terminal coupled to the first input of the second comparator, and the time-varying reference signal coupled to the second input of the second comparator;
wherein the controller is configured to generate a variable frequency gate drive signal applied to the gate drive terminal from the SR output, the frequency controlled based on the time-varying reference signal and a feedback signal received on the feedback terminal.

26. The buck-type power converter of claim 25 wherein the gate-drive controller is configured to assert the gate drive terminal when a feedback signal on the feedback terminal crosses the reference voltage, and the controller is configured to de-assert the gate drive terminal when a drain current signal on the drain current terminal crosses the time-varying reference signal.

27. The buck-type power converter of claim 25 wherein the reference signal circuit is configured to create at least one selected from a group comprising: the time-varying reference signal in the form of a triangle wave; and the time-varying reference signal in the form of a saw tooth wave.

28. The buck-type power converter of claim 25:
wherein the first comparator output is coupled directly to the set input of the bistable multivibrator; and
wherein the comparator output of the second comparator is coupled directly to the reset input of the bistable multivibrator.
